(19) United States
(12) Patent Application Publication
(10) Pub. No.: US 2020/0359168 A1
(43) Pub. Date: Nov. 12, 2020

(54) ELECTRONIC CIGARETTE, METHOD, AND DEVICE FOR SOCIAL INTERACTION BASED ON ELECTRONIC CIGARETTE

(71) Applicant: Goldtek Technology Co., Ltd., New Taipei City (TW)

(72) Inventors: YEN-CHING LEE, New Taipei (TW); PO-SHENG WANG, New Taipei (TW)

(21) Appl. No.: 16/573,171

(22) Filed: Sep. 17, 2019

(30) Foreign Application Priority Data
May 6, 2019 (TW) 108115538

(51) Int. Cl. H04W 4/02; G06Q 50/00; H04W 4/80; A24F 47/00; H04W 8/00; H04B 17/318

(52) U.S. Cl. CPC H04W 4/023; G06Q 50/01; H04B 17/318; A24F 47/002; H04W 8/005; H04W 4/80

(57) ABSTRACT

A method for enabling social interaction between users of electronic cigarettes is applied in a computer or server functioning as an electronic cigarette social device. The method includes receiving and processing a registration application from one or more local users of electronic cigarettes, generating individual registration records accordingly, and binding a device identification code of each electronic cigarette to each registration record. Scan data is received from an electronic cigarette, the scan data comprising the device identification codes of other local electronic cigarettes in communication with the first electronic cigarette. The device identification codes in the registration application and the scan data are matched to obtain user information of other electronic cigarettes, and a user list with respective signal strengths is generated and securely broadcast. A device also functioning as an electronic cigarette and an electronic cigarette social device are also disclosed.

### FIELD

The disclosure generally relates to electronic cigarettes.

### BACKGROUND

Electronic cigarettes are popular. However, an electronic cigarette presently has no data-sharing function or ability.

Surveys indicate that the purpose of smoking is not only to relax, but also to create and enhance friendships.

### BRIEF DESCRIPTION OF THE DRAWINGS

Implementations of the present technology will now be described, by way of embodiments, with reference to the attached figures.

FIG. 1 is a block diagram illustrating an embodiment of an electronic cigarette and an electronic cigarette social device.

FIG. 2 is a block diagram illustrating another embodiment of an electronic cigarette and an electronic cigarette social device.

FIG. 3 is a block diagram illustrating an embodiment of an electronic cigarette.

FIG. 4 is a block diagram illustrating an embodiment of an electronic cigarette system.

FIG. 5 is a block diagram illustrating an embodiment of an electronic cigarette social device.

FIG. 6 is a block diagram illustrating an embodiment of an electronic cigarette social system.

FIG. 7 is a flowchart illustrating an embodiment of a method for social interaction based on electronic cigarette.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

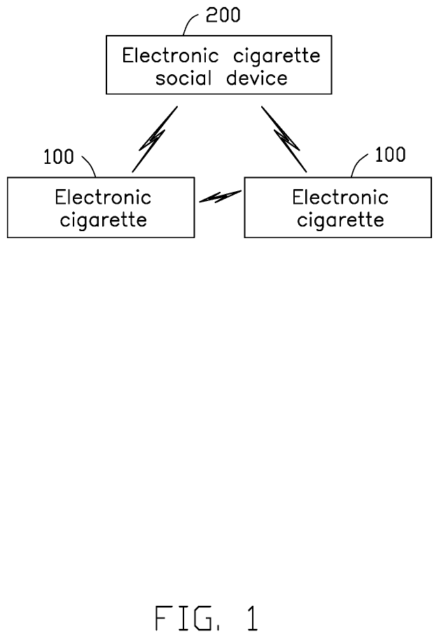

FIG. 1 illustrates an embodiment of an electronic cigarette 100 and an electronic cigarette social device 200. The electronic cigarette social device 200 can communicate directly with at least one electronic cigarette 100, and electronic cigarettes 100 can communicate with each other.

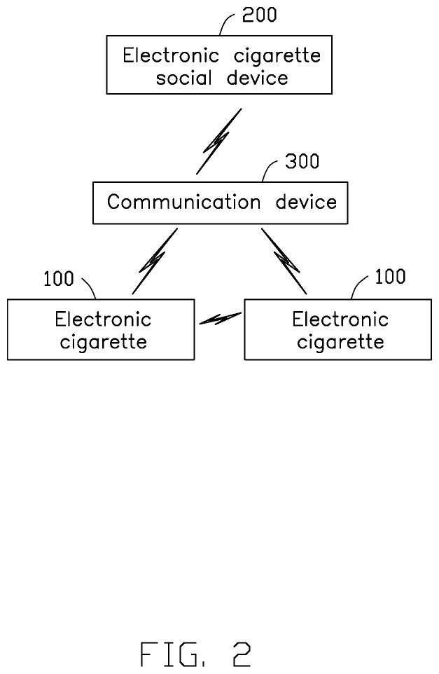

FIG. 2 illustrates another embodiment of the electronic cigarette 100 and the electronic cigarette social device 200. The electronic cigarette social device 200 communicates with at least one electronic cigarette 100 through a communication device 300. The communication device 300 can be an intelligent terminal or a TCP/IP protocol-based communication device 300 having a mobile communication function.

The electronic cigarette 100 can have a device identification code for uniquely identifying the electronic cigarette 100. The identification code can be, but is not limited to, a MAC address, a UID (user identification), an EID (device identification), or an IMEI (International Mobile Equipment Identity Code) of the electronic cigarette 100.

In other embodiments, when the electronic cigarette 100 seeks registration with the electronic cigarette social device 200, the electronic cigarette social device 200 generates a device identification code of the electronic cigarette 100 based on the MAC address, the UID, the EID or the IMEI, and transmits the device identification code to the electronic cigarette 100. The electronic cigarette 100 stores the device identification code locally, and ensures information security for the user of the electronic cigarette 100.

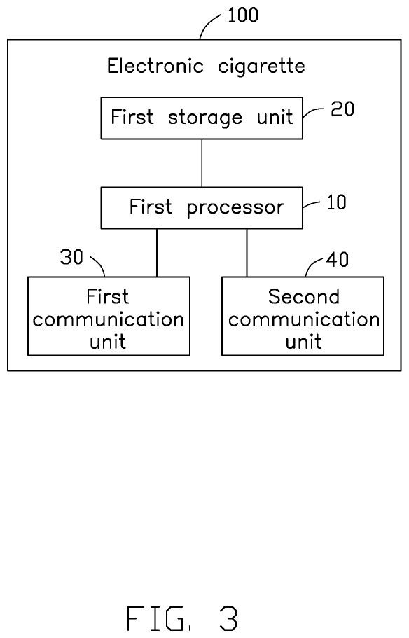

FIG. 3 illustrates that the electronic cigarette 100 includes a first processor 10, a first storage unit 20, a first communication unit 30, and a second communication unit 40. The first storage unit 20, the first communication unit 30, and the second communication unit 40 are electrically connected to the first processor 10. The first processor 10, the first storage unit 20, the first communication unit 30, and the second communication unit 40 can be integrated.

The device identification code may be the MAC address, the UID, the IMEI of the first communication unit 30 or the second communication unit 40. In at least one embodiment, the device identification code is the MAC address of the first communication unit 30, or the MAC address of the second communication unit 40.

The first processor 10 may include one or more central processing units (CPU), a microprocessor, a digital processing chip, a graphics processor, or a combination of various control chips.

The first storage unit 20 stores various types of data in the electronic device 10, such as program codes and the like.

The first storage unit 20 can be a hard disk, a floppy disk, a random access storage device, or the like.

In at least one embodiment, the first storage unit 20 can be an internal storage system, such as a flash memory, a random read storage device (RAM), a readable storage device (ROM).

In at least one embodiment, the first storage unit 20 can also be a storage system, such as a memory card or a data storage medium. The first storage unit 20 also includes a volatile and/or a non-volatile storage device.

The first communication unit 30 can wirelessly communicate with the electronic cigarette social device 200. The wireless communication method includes a 5G communication method, a 4G communication method, a 3G communication method, a 2G communication method, or a WI-FI, BLUETOOTH, or the like device based on the TCP/IP protocol.

The second communication unit 40 can establish a short-range communication with other electronic cigarettes 100 within a short distance. The plurality of the second communication units 40 can adopt an NFC protocol, a BLUETOOTH protocol, a WIFI protocol, a ZIGBEE protocol, a Z-WAVE protocol or a THREAD protocol for wireless communication. The THREAD protocol is the basis of the Internet of Things protocol technology.

When an user starts to use the electronic cigarette 100, the electronic cigarette 100 automatically searches for signals sent by other second communication units 40 of other electronic cigarettes 100. Signal strengths of other electronic cigarettes 100 are obtained, and first broadcast information is transmitted to the other electronic cigarettes 100 through the second communication unit 40. The first broadcast information includes the device identification code of the electronic cigarette 100. The signal strength is the strength of a signal sent by another second communication unit 40.

In other embodiments, when an user starts to use the electronic cigarette 100, the electronic cigarette 100 automatically searches for signals sent by other second communication units 40 of other electronic cigarettes 100, and obtains the signal strengths of other electronic cigarettes 100. A first broadcast information is transmitted to the other electronic cigarettes 100 through the second communication unit 40. The first broadcast information does not include the information of the electronic cigarette 100, it is only the related information of the second communication unit 40 which is included. Other electronic cigarettes 100 acquire the first broadcast information through the second communication unit 40, and send a second broadcast information through the second communication unit 40. The second broadcast information includes the device identification code of other electronic cigarettes 100. The electronic cigarette 100 receives the second broadcast information through the second communication unit 40, and obtains the device identification codes and the signal strengths of the other electronic cigarettes 100.

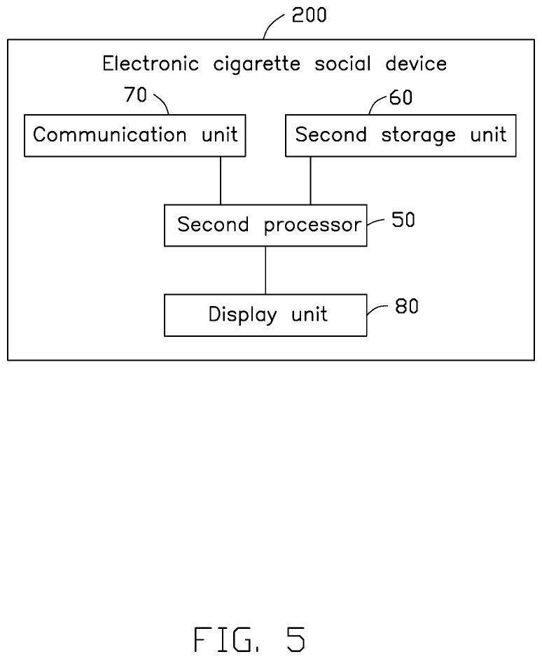

FIG. 5 illustrates that the electronic cigarette social device 200 includes a second processor 50, a second storage unit 60, a communication unit 70, and a display unit 80. The second storage unit 60, the communication unit 70, and the display unit 80 are electrically connected to the second processor 50. In at least one embodiment, the electronic cigarette social unit 200 can include one or more personal computers, or one or more servers.

The second processor 50 may include one or more CPUs, a microprocessor, a digital processing chip, a graphics processor, or a combination of various control chips.

The second storage unit 60 stores various types of data in the electronic cigarette social device 200, such as program codes and the like.

The second storage unit 60 can be a hard disk, a floppy disk, a random access storage device, or the like.

In at least one embodiment, the second storage unit 60 can be an internal storage system, such as a flash memory, a random access storage device (RAM), or a read-only storage device (ROM).

In at least one embodiment, the second storage unit 60 can also be a storage system, such as a memory card or a data storage medium. The second storage unit 60 also includes a volatile and/or a non-volatile storage device.

The communicating unit 70 can wirelessly communicate with the first communication unit 30 of at least one electronic cigarette 100, or communicate with the first communication unit 30 through the communication device 300.

The display unit 80 is configured to display various information processed by the second processor 70. The display unit 80 can be a display device, a touch panel, or the like.

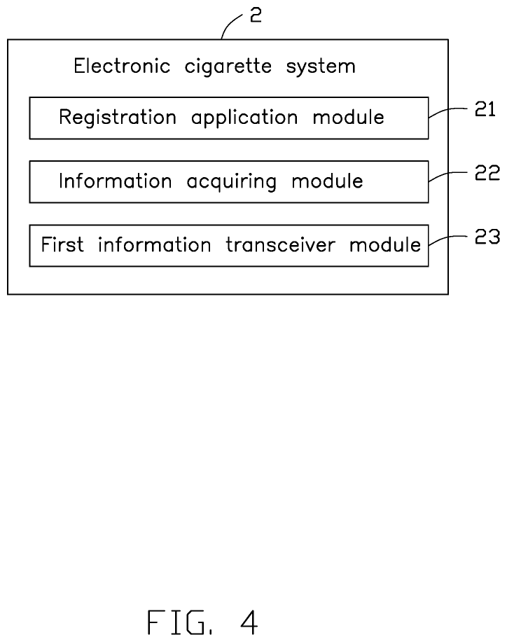

FIG. 4 shows an electronic cigarette system 2 running in the electronic cigarette 100. The electronic cigarette system 2 may include a plurality of modules, which are a collection of software instructions stored in the first storage unit 20 and executable by the first processor 10. In the embodiment as disclosed, the electronic cigarette system 2 can include an registration application module 21, an information acquiring module 22, and a first information transceiver module 23.

The registration application module 21 is configured to process a registration application or cancellation application of the electronic cigarette 100 in the electronic cigarette social device 200, and the device identification code of the electronic cigarette 100 is bound to the registration application. The registration application includes the user information.

The information acquiring module 22 acquires a scan data collected by the second communication unit 40, and the scan data includes one or more of the device identification codes and signal strengths of other electronic cigarettes 100 in communication with the electronic cigarette 100.

The first information transceiver module 23 transmits the scan data to the electronic cigarette social device 200 through the first communication unit 30.

The electronic cigarette 100 transmits the scan data to the electronic cigarette social device 200. Thereby, the electronic cigarette social device 200 obtains user information according to the device identification code in the scan data, the user information including the user's name and contact information. The user information may provide an image or symbol of the user for viewing, and the user information of other e-cigarette users in the vicinity is recommended to the e-cigarette user, thereby realizing the social enhancement purposes of the e-cigarette user.

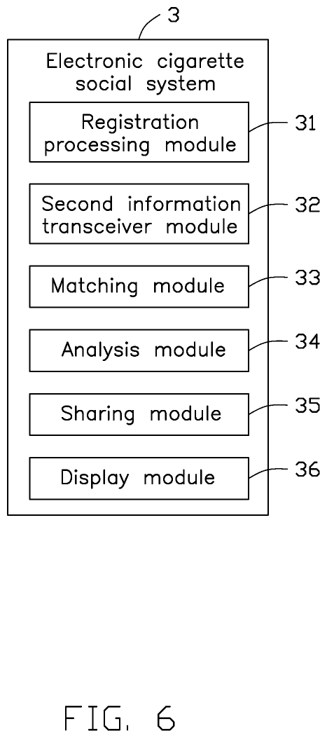

FIG. 6 shows an electronic cigarette social system 3 running in the electronic cigarette social device 200. The electronic cigarette social system 3 may include a plurality of modules, which is a collection of software instructions stored in the second storage device 60 and executable by the second processor 50. In the embodiment as disclosed, the electronic cigarette social system 3 can include a registration processing module 31, a second information transceiver module 32, a matching module 33, an analysis module 34, a sharing module 35, and a display module 36.

The registration processing module 31 processes the registration application of the electronic cigarette 100, generates a registration record according to the registration application, and binds the device identification code of the electronic cigarette 100 to the registration record during the registration process. The registration processing module 31 is further configured to process a cancellation application of the electronic cigarette 100 and if so to cancel the registration record.

In at least one embodiment, the electronic cigarette social device 200 acquires, from its client, the registration application input by the user of the electronic cigarette 100, generates the registration record, and binds the registration record to the device identification code. The registration application includes the user information, such as the a user's name, contact information, and the like, but is not limited thereto. The client may be an APP of a smart terminal or a software of a computer.

In other embodiments, during the registration process, the electronic cigarette social device 200 performs wireless communication with the first communication unit 30 or the second communication unit 40 of the electronic cigarette 100. Sensors of the electronic cigarette 100 can sense a button push or a physical shaking of the electronic cigarette 100, thereby the first communication unit 30 or the second communication unit 40 transmits the device identification code to the electronic cigarette social device 200, and implements binding of the registration record to the device identification code of the electronic cigarette 100.

The second information transmitting module 32 transmits and receives information. The second information transmitting module 31 can receive the scan data transmitted from the electronic cigarette 100.

The matching module 33 matches the device identification codes in the registration record and the scan data to obtain the user information, and generates a user list.

The analysis module 34 analyzes the signal strength in the scan data and can sort the user list according to the signal strengths.

The sharing module 35 generates a sharing information according to the user list, and can share the sharing information to a social platform.

The display module 36 controls the display unit 90 to display the sharing information and the user list.

The electronic cigarette social device 200 receives the scan data sent by the electronic cigarette 100, and obtains the user information by matching the device identification codes in the scan data and the registration record. The user can view the user information of other e-cigarette users in the vicinity.

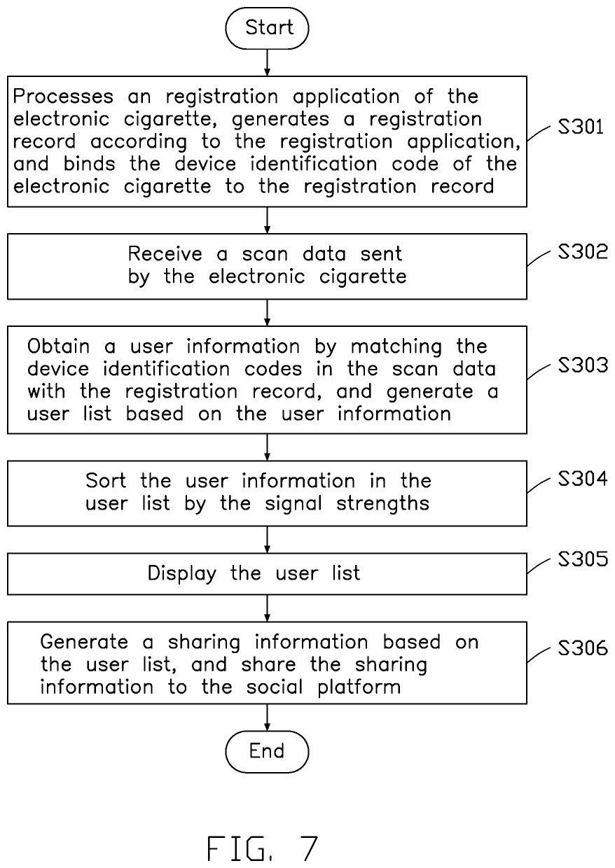

An electronic cigarette social method is illustrated in FIG. 7. The method is provided by way of embodiments, as there are a variety of ways to carry out the method. Each block shown in FIG. 7 represents one or more processes, methods, or subroutines carried out in the example method. Additionally, the illustrated order of blocks is by example only and the order of the blocks can be changed. The method can begin at block S301.

At block S301, the electronic cigarette social device 200 processes a registration application of the electronic cigarette 100, generates a registration record according to the registration application, and binds the device identification code of the electronic cigarette 100 to the registration record the during the registration process.

The registration processing module 31 of the electronic cigarette social device 200 may process a registration application of the electronic cigarette 100, generate a registration record according to the registration application information, and binds the device identification code of the electronic cigarette 100 to the registration record the during the registration process.

At block S302, the scan data sent by the electronic cigarette 100 is received.

Specifically, the second information transceiver module 32 of the electronic cigarette social device 200 receives the scan data sent by the first information transceiver module 23 of the electronic cigarette 100. The scan data may be collected by the second communication unit 40 provided in the electronic cigarette 100, and the scan data includes at least one of the device identification codes and the corresponding signal strengths of other electronic cigarettes 100 in the vicinity of the electronic cigarette 100.

At block S303, the user information is obtained by matching the device identification codes in the scan data with the registration record, and a user list is generated based on the user information.

Specifically, the matching module 33 matches the at least one device identification code in the scan data with the registration record to obtain the user information corresponding to the scan data, and generates the user list base on the user information.

At block S304, the user information in the user list is sorted according to the signal strengths.

Specifically, the analysis module 34 sorts the user information in the user list according to the signal strengths. For example, the user information is arranged in ascending or descending order according to the strengths of the signals, which is convenient for the user to view.

At block S305, the user list is displayed.

Specifically, the display module 36 controls the display unit 80 to display the user list, so that the electronic cigarette user can view the scanned user information and understand the situation of the electronic cigarette users nearby, thereby achieving the purpose of socializing.

At block S306, a sharing information is generated according to the user list and shared to a social platform.

Specifically, the sharing module 35 of the electronic cigarette social device 200 generates the sharing information according to the user list, and shares the sharing information to the social platform.

In other embodiments, after the block S305, the method further includes: the second information transceiver module 32 of the electronic cigarette social device 200 transmits the user list to a short message server or an E-mail server, that is, the user list is sent to the user of the electronic cigarette 100 by SMS or E-mail.

In other embodiments, the electronic cigarette social method may only include the processes at block S301 to S303.

In the electronic cigarette social method, the electronic cigarette 100 sends the scan data to the electronic cigarette social device 200, and the electronic cigarette social device 200 matches the device identification codes in the scan data with the registration record to obtain the user information corresponding to the scan data. The user of the electronic cigarette 100 can find other users nearby, and can use the electronic cigarette together to enhance the friendship between friends. The user can also view the e-cigarette users to have friends with the same e-cigarette usage habits.

A person skilled in the art can understand that all or part of the processes in the above embodiments can be implemented by a computer program to instruct related hardware, and that the program can be stored in a computer readable storage medium. When the program is executed, a flow of steps of the methods as described above may be included.

In addition, each functional device in each embodiment may be integrated in one processor, or each device may exist physically separately, or two or more devices may be integrated in one device. The above integrated device can be implemented in the form of hardware or in the form of hardware plus software function modules.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

1. An electronic cigarette, comprising:
a first communication unit configured to communicate with an electronic cigarette social device directly or through a communication device;
a second communication unit configured to establish a short-range communication with other electronic cigarettes;
at least one processor; and
at least one storage unit storing one or more programs, when executed by the processor, the one or more programs cause the processor to:
process a registration application with the electronic cigarette social device, and bind a device identification code to the registration application, wherein the registration application comprises a user information;
acquire a scan data through the second communication unit, wherein the scan data comprises at least one of the device identification codes of other electronic cigarettes; and
transmit the scan data to the electronic cigarette social device through the first communication unit.

2. The electronic cigarette of claim 1, wherein the device identification code is a MAC address, a UID, or an IMEI of the first communication unit or the second communication unit.

3. The electronic cigarette of claim 1, wherein the scan data further comprises signal strengths of the other electronic cigarettes.

4. The electronic cigarette of claim 1, wherein the second communication units of the plurality of electronic cigarettes performs wireless communication using an NFC protocol, a Bluetooth protocol, a WiFi protocol, a ZigBee protocol, a Z-Wave protocol, or a Thread protocol.

5. An electronic cigarette social device, comprising:
a communication unit configured to communicate with at least one electronic cigarette directly or through a communication device;
at least one processor; and
at least one storage unit storing one or more programs, when executed by the processor, the one or more programs cause the processor to:
processes a registration application comprising a user information of the electronic cigarette, generate a registration record according to the registration application, and bind a device identification code of the electronic cigarette to the registration record;
receive, from the electronic cigarette, a scan data comprising at least one of the device identification codes of other electronic cigarettes;
match the at least one of the device identification codes in the registration record and the scan data to obtain the user information of the other electronic cigarettes, and generate a user list.

6. The electronic cigarette social device of claim 5, wherein the scan data comprises signal strengths of other electronic cigarettes, and the one or more programs further cause the processor to:
analyze the signal strengths of other electronic cigarettes in the scan data and sort the user information in the user list according to the signal strengths.

7. The electronic cigarette social device of claim 5, wherein the one or more programs further cause the processor to:
generate a sharing information according to the user list, and share the sharing information to a social platform.

8. The electronic cigarette social device of claim 5, wherein the electronic cigarette social device further comprises a display unit, and the one or more programs further cause the processor to:
control the display unit to display the user list.

9. The electronic cigarette social device of claim 5, wherein the electronic cigarette social device communicates with the electronic cigarette directly or through a communication device.

10. The electronic cigarette social device of claim 5, wherein the device identification code is a MAC address, a UID, or an IMEI of the electronic cigarette.

11. An electronic cigarette social method, applied to an electronic cigarette social device, the method comprising:
processing a registration application comprising a user information of the electronic cigarette, generating a registration record according to the registration application, and binding a device identification code of the electronic cigarette to the registration record;
receiving a scan data from an electronic cigarette, the scan data comprising at least one of the device identification codes of other electronic cigarettes which is in communication with the electronic cigarette;
matching the at least one of the device identification codes in the registration record and the scan data to obtain the user information of the other electronic cigarettes, and generating a user list.

12. The electronic cigarette social method of claim 11, wherein the scan data comprises signal strengths of the other electronic cigarettes, after generating the user list, the method further comprising:
analyzing the signal strengths of other electronic cigarettes in the scan data and sorting the user list according to the signal strengths.

13. The electronic cigarette social method of claim 11, after generating the user list, the method further comprising:
displaying the user list.

14. The electronic cigarette social method of claim 11, after generating the user list, the method further comprising:
generating a sharing information according to the user list, and sharing the sharing information to a social platform.

15. The electronic cigarette social method of claim 11, wherein the electronic cigarette social device communicates with the electronic cigarette directly or through a communication device, and the electronic cigarette establish a short-range communication with other electronic cigarettes.

16. The electronic cigarette social method of claim 11, wherein the device identification code is a MAC address, a UID, or an IMEI of the electronic cigarette.
